(19) United States
(12) Patent Application Publication
(10) Pub. No.: US 2024/0334359 A1
(43) Pub. Date: Oct. 3, 2024

(54) METHOD FOR TIMING ADVANCE MAINTENANCE IN UPLINK SYNCHRONIZATION, TERMINAL DEVICE, AND CHIP

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(21) Appl. No.: 18/742,880

(22) Filed: Jun. 13, 2024

Related U.S. Application Data
(63) Continuation of application No. PCT/CN2021/138178, filed on Dec. 15, 2021.

(51) Int. Cl. H04W 56/00; H04W 74/0833; H04W 76/20; H04W 76/30

(52) U.S. Cl. CPC H04W 56/0045; H04W 74/0833; H04W 76/20; H04W 76/30

(57) ABSTRACT

A method for timing advance (TA) maintenance in uplink (UL) synchronization, a terminal device, and a chip are provided in embodiments of the disclosure. The method includes the following. A terminal device in a radio resource control (RRC) inactive state triggers a random access procedure in UL small data transmission (SDT) based on a pre-configured resource. In the random access procedure, the pre-configured resource and/or a corresponding first timer is operated to maintain validity of a TA.

### CROSS REFERENCE TO RELATED APPLICATION(S)

This application is a continuation of International Application No. PCT/CN2021/138178, filed Dec. 15, 2021, the entire disclosure of which is incorporated herein by reference.

### TECHNICAL FIELD

This disclosure relates to the field of communications, and more particularly to a method for timing advance (TA) maintenance in uplink (UL) synchronization, a terminal device, and a chip.

### BACKGROUND

At present, a user equipment (UE) does not support small data transmission (SDT) (i.e., transmission of a small number of small data packets) in a radio resource control (RRC) inactive (RRC_INACTIVE) state, and can perform the SDT only in an RRC connected (RRC_CONNECTED) state. However, switching of the UE between different states (e.g., switching between the RRC_INACTIVE state and the RRC_CONNECTED state) consumes many resources of the UE, and thus the SDT is required to be implemented in the RRC_INACTIVE state.

In order to implement the SDT in the RRC_INACTIVE state, it is required to satisfy uplink (UL) synchronization and maintain validity of a timing advance (TA).

### SUMMARY

In a first aspect, a method for TA maintenance in UL synchronization is provided. The method is applied to a terminal device and includes the following. The terminal device in an RRC_INACTIVE state triggers a random access procedure in UL SDT based on a pre-configured resource. In the random access procedure, the pre-configured resource and/or a corresponding first timer is operated to maintain validity of a TA.

In a second aspect, a terminal device is provided. The terminal device includes a processor and a memory. The memory is configured to store computer programs. The processor is configured to invoke and execute the computer programs stored in the memory, to cause the terminal device to: trigger, in a radio resource control (RRC) inactive state, a random access procedure in uplink (UL) small data transmission (SDT) based on a pre-configured resource, and operate the pre-configured resource and/or a corresponding first timer to maintain validity of a timing advance (TA), in the random access procedure.

In a third aspect, a chip is provided. The chip includes a processor. The processor is configured to invoke and execute computer programs stored in a memory, to cause a device equipped with the chip to: trigger, in a radio resource control (RRC) inactive state, a random access procedure in UL small data transmission (SDT) based on a pre-configured resource, and in the random access procedure, operate the pre-configured resource and/or a corresponding first timer to maintain validity of a TA.

### BRIEF DESCRIPTION OF THE DRAWINGS

FIG. 1 is a schematic diagram illustrating an application scenario according to embodiments of the disclosure.

FIG. 2 is a schematic flowchart illustrating user plane-early data transmission (UP-EDT) according to embodiments of the disclosure.

FIG. 3 is a schematic flowchart illustrating pre-configured uplink resource (PUR) data transmission according to embodiments of the disclosure.

FIG. 4 is another schematic diagram illustrating an application scenario according to embodiments of the disclosure.

FIG. 5 is a schematic flowchart illustrating a method for timing advance (TA) maintenance in uplink (UL) synchronization according to an embodiment of the disclosure.

FIG. 6 is a schematic flowchart illustrating a method for TA maintenance in UL synchronization according to an embodiment of the disclosure.

FIG. 7 is a schematic flowchart illustrating a method for TA maintenance in UL synchronization according to an embodiment of the disclosure.

FIG. 8 is a schematic flowchart illustrating a method for TA maintenance in UL synchronization according to an embodiment of the disclosure.

FIGS. 9 to 12 are schematic diagrams each illustrating a procedure of initiating a random access procedure by a user equipment (UE) in a configured grant-small data transmission (CG-SDT) scenario in an example of a method for TA maintenance in UL synchronization according to an embodiment of the disclosure.

FIG. 13 is a schematic block diagram illustrating a terminal device according to an embodiment of the disclosure.

FIG. 14 is a schematic block diagram illustrating a terminal device according to an embodiment of the disclosure.

FIG. 15 is a schematic block diagram illustrating a network device according to an embodiment of the disclosure.

FIG. 16 is a schematic block diagram illustrating a network device according to an embodiment of the disclosure.

FIG. 17 is a schematic block diagram illustrating a communication device according to embodiments of the disclosure.

FIG. 18 is a schematic block diagram illustrating a chip according to embodiments of the disclosure.

FIG. 19 is a schematic block diagram illustrating a communication system according to embodiments of the disclosure.

### DETAILED DESCRIPTION

The following will illustrate technical solutions of embodiments of the disclosure with reference to accompanying drawings of embodiments of the disclosure.

The technical solutions in embodiments of the disclosure can be applicable to various communication systems, for example, a global system of mobile communication (GSM), a code division multiple access (CDMA) system, a wideband code division multiple access (WCDMA) system, a general packet radio service (GPRS) system, a long-term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5^{th} generation (5G) system, or other communication systems.

Generally speaking, a conventional communication system supports a limited number of connections and therefore is easy to implement. However, with development of communication technology, a mobile communication system not only supports conventional communication but also supports, for example, device to device (D2D) communication, machine to machine (M2M) communication, machine type communication (MTC), and vehicle to vehicle (V2V) communication. Embodiments herein can also be applicable to these communication systems.

Optionally, a communication system in embodiments of the disclosure can be applicable to a carrier aggregation (CA) scenario, a dual connectivity (DC) scenario, and a standalone (SA) scenario.

Optionally, the communication system in embodiments of the disclosure can be applicable to an unlicensed spectrum, where the unlicensed spectrum can also be regarded as a shared spectrum. Alternatively, the communication system in embodiments of the disclosure can also be applicable to a licensed spectrum, where the licensed spectrum can also be regarded as an unshared spectrum.

Embodiments of the disclosure are described in conjunction with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, a user device, etc.

The terminal device may be a station (STA) in a WLAN, a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a next-generation communication system such as an NR network, a terminal device in a future evolved public land mobile network (PLMN), etc.

In embodiments of the disclosure, the terminal device may be deployed on land, for example, deployed indoors or outdoors, and may be handheld, wearable, or vehicle-mounted. The terminal device may also be deployed on water, for example, on a ship, etc. The terminal device may also be deployed in the air, for example, on an airplane, an air balloon, a satellite, etc.

In embodiments of the disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

By way of example rather than limitation, in embodiments of the disclosure, the terminal device may also be a wearable device. The wearable device may also be referred to as a wearable smart device, which is a generic term of wearable devices obtained through intelligentization designing and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device. The network device may be an access point (AP) in the WLAN, a base transceiver station (BTS) in the GSM or CDMA, may also be a Node B (NB) in the WCDMA, and may further be an evolved Node B (eNB or eNodeB) in the LTE, a relay station or AP, an in-vehicle device, a wearable device, a gNodeB (gNB) in the NR network, a network device in the future evolved PLMN, a network device in the NTN, or the like.

By way of example rather than limitation, in embodiments of the disclosure, the network device may be of mobility. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station located on land, water, etc.

In embodiments of the disclosure, the network device may provide services for a cell, and the terminal device communicates with the network device through a transmission resource (e.g., a frequency domain resource or a spectrum resource) for the cell. The cell may be a cell corresponding to the network device (e.g., a base station). The cell may belong to a macro base station, and may also belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

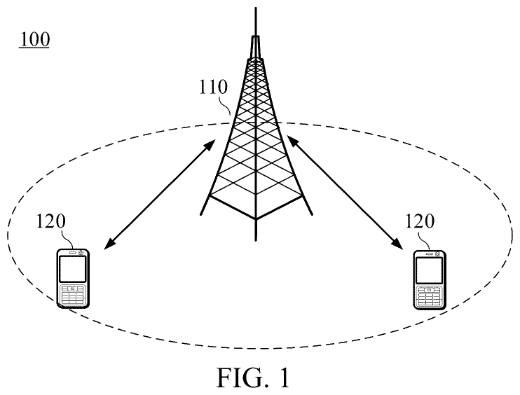

FIG. 1 exemplarily illustrates a communication system 100. The communication system 100 includes one network device 110 and two terminal devices 120. Optionally, the communication system 100 may include multiple network devices 110, and there may be other numbers of terminal devices 120 in the coverage of each network device 110, which is not limited herein.

Optionally, the communication system 100 may further include other network entities such as a mobility management entity (MME), an access and mobility management function (AMF), etc., which is not limited herein.

The network device may further include an access network device and a core network device, i.e., a wireless communication system further includes multiple core networks for communication with the access network device. The access network device may be an eNB or e-node B, a macro base station, a micro base station (also referred to as a “small base station”), a pico base station, an AP, a transmission point (TP), a gNB, or the like in an LTE system, an NR system, or an authorized auxiliary access long-term evolution (LAA-LTE) system.

It may be understood that, a device with a communication function in a network/system in embodiments of the disclosure can be called a communication device. Taking the communication system illustrated in FIG. 1 as an example, the communication device may include the network device and the terminal device that have communication functions, and the network device and the terminal device may be specific devices in embodiments of the disclosure, which may not be repeated herein. The communication device may further include other devices in the communication system, e.g., a network controller, an MME, or other network entities, which may not be limited in embodiments of the disclosure.

It may be understood that, the terms “system” and “network” herein are usually interchangeable. The term “and/or” herein merely describe an association relationship between associated objects and represents that three relationships may exist. For example, A and/or B may represent the following three cases: only A exists, both A and B exist, and only B exists. In addition, the character “/” herein generally indicates an “or” relationship between the associated objects.

It may be understood that, the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation.

In the description of embodiments of the disclosure, the term “corresponding” can mean that there is a direct or indirect correspondence between two elements, or that there is an association between two elements, or that there is a relationship of “indicating” and “being indicated”, “configuring” and “being configured”, and the like.

In order to facilitate understanding of the technical solutions of embodiments of the disclosure, the following describes the related technologies of embodiments of the disclosure. The related technologies below as an optional solution may be arbitrarily combined with the technical solutions of embodiments of the disclosure, and any combination thereof may belong to the scope of protection of embodiments of the disclosure.

Small data transmission (SDT) has been introduced in the LTE. In early data transmission (EDT), a UE may always remain in a radio resource control (RRC) idle (RRC_IDLE) state, an RRC suspended (RRC_suspend) state, or an RRC inactive (RRC_INACTIVE) state to complete transmission of an uplink (UL) small data packet and/or a downlink (DL) small data packet. In terms of configuration, a network device (e.g., a base station) may configure, on a system information block (SIB) 2, a maximum transport block (TB) size allowed for transmission by a current network. The UE determines a volume of data to-be-transmitted. If the volume of the data to-be-transmitted is less than the maximum TB size broadcasted, the UE may initiate the EDT, otherwise, the UE may enter a connected state for data transmission through a conventional connection establishment procedure.

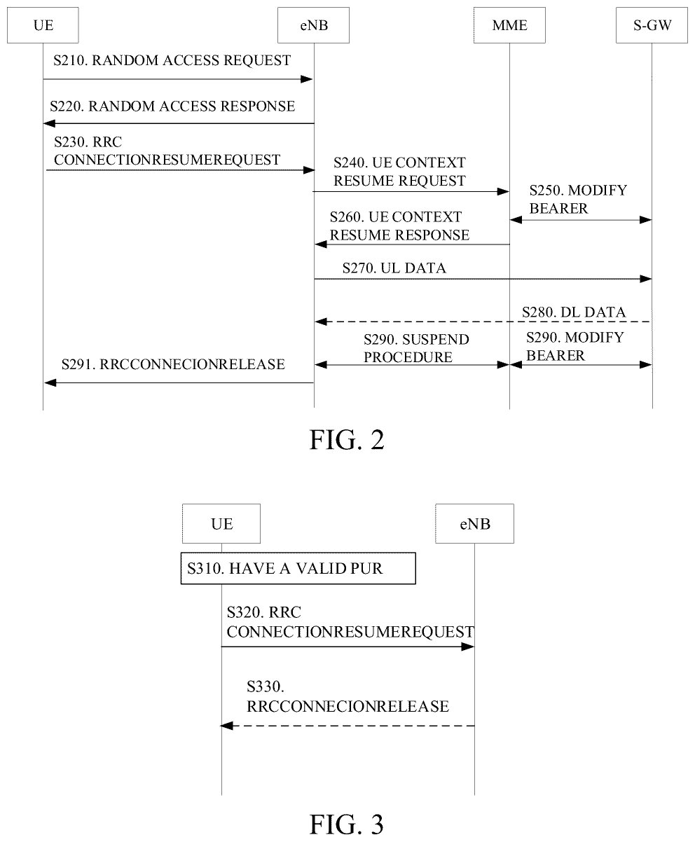

If a cell in which the UE initiates user plane-early data transmission (UP-EDT) is the same as the last serving cell, the network device can directly deliver UL data to a core network after receiving a connection resume request and the UL data transmitted by the UE. The UP-EDT is illustrated in FIG. 2 and includes at least part or all of the following.

S210, the UE initiates a random access request to an eNB.

S220, the eNB feeds back a random access response (RAR) to the UE.

S230, the UE initiates an RRC ConnectionResumeRequest to the eNB. The RRC ConnectionResumeRequest includes: a resumeID, a resumeCause, a shortResumeMAC-I, and UL data. The resumeID, as an identifier (ID) of a UE access stratum (AS) context, is a unique UE ID in an RRC connection resume procedure and is typically of 40 bits. The resumeCause represents an access type (e.g., mobile terminated (MT) access, a mobile originated (MO) signaling, data, abnormal data, or delay tolerant access) and is typically of 3 bits. The shortResumeMAC-I is used to identify and validate the UE and is typically of 16 bits.

S240, the eNB initiates an S1-application protocol (S1-AP) signaling, i.e., a UE context resume request, to an MME.

S250, a modify bearer is established between the MME and a serving gateway (S-GW).

S260, the S-GW feeds back an S1-AP signaling, i.e., a UE context resume response, to the MME.

S270, the eNB initiates an UL data transmission request to the S-GW.

S280, the S-GW transmits DL data.

S290, the modify bearer and a suspended procedure are established between the MME and the S-GW.

S291, the eNB feeds back an RRCConnecionRelease to the UE. The RRCConnecionRelease includes: a releaseCause, a resumeID, a NextHoppingChaningCount (NCC), and the DL data.

In LTE release 16, for a narrow band-internet of things (NB-IoT) scenario and an enhanced machine-type communication (eMTC) scenario, a method for data transmission using a pre-configured uplink resource (PUR) in an idle state is introduced. The PUR is valid only in a currently configured cell. In other words, when the UE detects cell change and initiates random access in a new cell, the UE needs to release a PUR configured for an original cell. PUR data transmission is similar to the UP-EDT, except that a procedure of transmitting a preamble to obtain a tracking area (TA) and an UL grant is omitted in the PUR data transmission. As illustrated in FIG. 3, the PUR data transmission includes at least part or all of the following. S310, the UE has a valid PUR.

S320, the UE initiates an RRC ConnectionResumeRequest to the eNB. The RRC ConnectionResumeRequest includes: a resumeID, an establishment cause, a shortResumeMAC-I, and UL data.

S330, the eNB feeds back an RRCConnecionRelease to the UE. The RRCConnecionRelease includes: a releaseCause, a resumeID, an NCC, DL data, and a timing advance command (TAC).

In a 5G NR system, an RRC state is classified into three types: an RRC_IDLE state, an RRC_INACTIVE state, and an RRC connected (RRC_CONNECTED) state. The RRC_INACTIVE state is a new state introduced in a 5G system for the sake of power saving. For the UE in the RRC_INACTIVE state, a radio bearer and all radio resources are released, but only an access context of the UE is reserved at a UE side and a network device side, so as to facilitate quick resume of an RRC connection. Generally, the network device configures a UE with infrequent data transmission to remain in the RRC_INACTIVE state.

Before the LTE release 16, the UE in the RRC_INACTIVE state does not support data transmission. When MO data (i.e., short message data transmitted from a transmitter UE to a short message center through the network device and stored in the short message center) or MT data (i.e., short message data forwarded from the short message center to a receiver UE) arrives, the UE needs to resume a connection, and after data transmission is completed, the UE is released to the RRC_INACTIVE state. For a UE with a small data volume and infrequent transmission, such a transmission mechanism may cause unnecessary power consumption and signaling overhead. In other words, the UE does not support data transmission in the RRC_INACTIVE state, and can perform data transmission only in the RRC_CONNECTED state. However, switching of the UE between different states certainly increases overhead at the UE side. Therefore, it is required to study out a solution for SDT in the RRC_INACTIVE state.

The solution for UL SDT in the RRC_INACTIVE state mainly includes the following two scenarios.

Scenario 1: the UL SDT is implemented based on a pre-configured resource (e.g., configured grant (CG) type 1) (hereinafter CG-SDT for short).

Scenario 2: the UL SDT is implemented based on a 2-step or 4-step random access procedure (the random access procedure is used to transmit control information, e.g., an UL transmission channel for requesting connection establishment, from a terminal device, and can also be used to transmit a small number of packet data from the terminal device to the network device) (hereinafter RA-SDT for short).

In the RRC_INACTIVE state, the SDT is an optional manner for UL data transmission, and a key feature of the UL data transmission is orthogonal multiple access in time and frequency between different UEs, that is, UL transmissions of different UEs from the same cell do not interfere with each other. In order to ensure orthogonality between UL transmissions and avoid intra-cell interference, the network device requires that arrivals of signals from different UEs in the same subframe but different frequency-domain resources at the network device are time-aligned. The network device can correctly decode UL data as long as the network device receives, within a cyclic prefix (CP), the UL data transmitted by the UE. Therefore, an UL synchronization requirement is that times when signals from different UEs in the same subframe arrive at the network device are within the CP.

In the RRC_INACTIVE state, the SDT is an optional manner for the UL data transmission, and is also required to satisfy the UL synchronization requirement. In other words, validity of a TA (the TA is the amount of time by which UL transmission needs to be advanced by the terminal device and is notified to the terminal device in a command transmitted by the network device to the terminal device to adjust its UL transmission) is required to be maintained in both the CG-SDT scenario and the RA-SDT scenario, so as to achieve UL synchronization.

In a possible manner, for the CG-SDT scenario and the RA-SDT scenario, the UE may use different timers for different random access procedures or different RRC states to maintain the validity of the TA, respectively. For example, for the CG-SDT scenario, the UE may maintain the validity of the TA by using a first timer (e.g., an SDT-timing advance timer (TAT), where the SDT-TAT herein is merely used to refer to the first timer, and the specific name or selection of the first timer is not limited herein). For the RA-SDT scenario, the UE may maintain the validity of the TA by using, according to a random access procedure and a connected state, a second timer (e.g., a TAT, where the TAT herein is merely used to refer to the second timer, and the specific name or selection of the second timer is not limited herein) configured in system broadcast.

By means of the embodiments of the disclosure, different timers can be respectively used for the two scenarios above to maintain the validity of the TA, thereby at least solving the problem of how to deal with coexistence of the first timer and the second timer when the UE initiates different random access procedures or enters different RRC states (e.g., an RRC_IDLE state, an RRC_INACTIVE state, or an RRC_CONNECTED state). All solutions for maintaining the validity of the TA through respective timers for the two scenarios above may fall into the scope of protection of the disclosure.

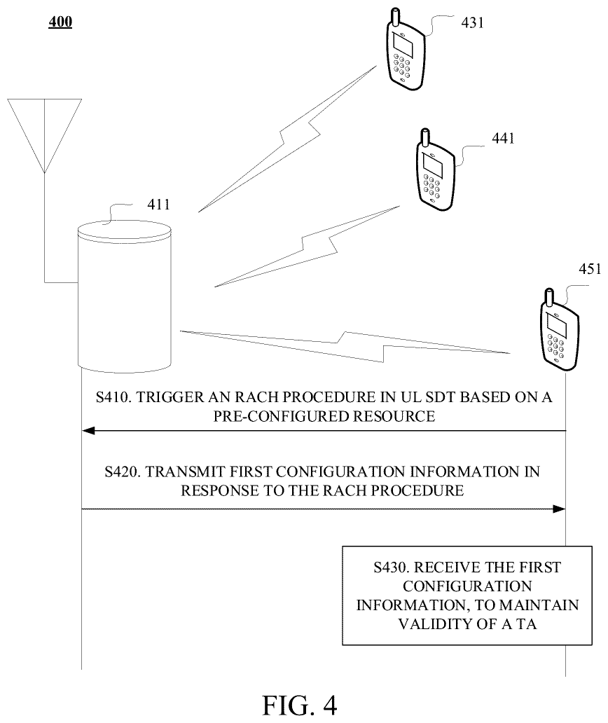

The network device may configure a pre-configured resource and/or a TA for the terminal device, so that the terminal device (e.g., a mobile phone) in the RRC_INACTIVE state can implement SDT, and UL synchronization can be satisfied by maintaining the validity of the TA. FIG. 4 is another schematic diagram illustrating an application scenario according to embodiments of the disclosure and exemplarily illustrates an information interaction procedure of a method 400 for TA maintenance in UL synchronization according to embodiments of the disclosure. For example, a base station serves as the network device, and a mobile phone serves as the terminal device. A base station 411 communicates with a mobile phone 431, a mobile phone 441, and a mobile phone 451. For example, the base station 411 communicates with the mobile phone 451, and the information interaction procedure includes part or all of the following.

S410, the terminal device in an RRC_INACTIVE state triggers a random access procedure in UL SDT based on a pre-configured resource.

S420, the base station transmits first configuration information to the terminal device in response to the random access procedure, where the first configuration information includes at least the pre-configured resource and/or a TA.

S430, the terminal device receives the first configuration information in the random access procedure, and operates the pre-configured resource and/or a corresponding first timer, to maintain validity of the TA.

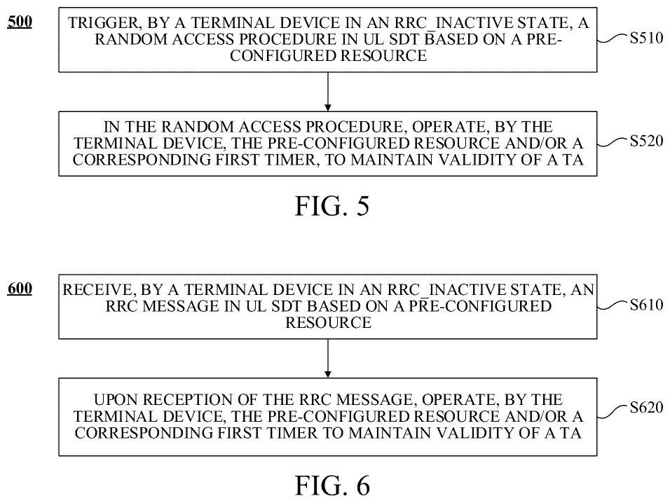

FIG. 5 is a schematic flowchart illustrating a method 500 for TA maintenance in UL synchronization according to an embodiment of the disclosure. The method may be optionally applied to the system illustrated in FIG. 1, but is not limited thereto. The method includes at least part of the following.

S510, a terminal device in an RRC_INACTIVE state triggers a random access procedure in UL SDT based on a pre-configured resource.

S520, in the random access procedure, the terminal device operates the pre-configured resource and/or a corresponding first timer, to maintain validity of a TA.

In some examples, in the random access procedure, the terminal device may maintain the validity of the TA through the first timer (for example, the TA currently maintained by the first timer is valid when the first timer is in a running state); and/or in the random access procedure, the terminal device may maintain the validity of the TA according to change in reference signal power (for example, the TA is valid if the change in the reference signal power does not exceed a threshold).

It may be noted that, in the random access procedure, the terminal device operates the pre-configured resource and/or the corresponding first timer, to maintain the validity of the TA as follows. After the terminal device receives the pre-configured resource and/or the corresponding first timer transmitted by the network device, the terminal device may release the pre-configured resource according to different release occasions and stop the first timer in the running state to maintain the validity of the TA. In order to maintain the validity of the TA, a value of the TA currently maintained by the first timer is determined according to a value indicated by a TAC in a DL message transmitted by the network device. The TAC is a command transmitted by the network device to the terminal device to adjust its UL transmission, and the terminal device is notified, through the TAC, that the validity of the TA in UL transmission is required to be maintained, to realize the UL synchronization.

By means of the embodiments of the disclosure, after the random access procedure is triggered in the CG-SDT scenario, the validity of the TA can be maintained in various manners, such as a timer and/or reference signal power.

In a possible implementation, in the random access procedure, the pre-configured resource and/or the corresponding first timer is operated to maintain the validity of the TA as follows. The terminal device releases the pre-configured resource (e.g., a CG-SDT resource) and stops the first timer. The first timer is used to maintain the validity of the TA in the UL SDT based on the pre-configured resource.

In some examples, different release occasions for the terminal device to release the pre-configured resource (e.g., a CG-SDT resource) include any one of the following.

Manner 1: when initiating the random access procedure, the terminal device can release the pre-configured resource (e.g., a CG-SDT resource).

Manner 2: when contention resolution in the random access procedure succeeds, the terminal device can release the pre-configured resource (e.g., a CG-SDT resource).

Manner 3: after the contention resolution in the random access procedure succeeds and a reception acknowledgement (ACK) indication is transmitted, the terminal device can release the pre-configured resource (e.g., a CG-SDT resource).

In a possible implementation, the pre-configured resource is released and the first timer is stopped as follows. Upon initiating the random access procedure, the pre-configured resource is released, and the first timer (the first timer may be denoted as an SDT-TAT) in the running state is stopped. In the random access procedure, a DL message (e.g., an RAR including a TAC or a message B (MsgB) including a TAC) is received and a second timer (the second timer may be denoted as a TAT) is started.

In a possible implementation, the pre-configured resource is released and the first timer is stopped as follows. When the contention resolution in the random access procedure succeeds, the pre-configured resource is released, and the first timer (the first timer may be denoted as an SDT-TAT) in the running state is stopped. In the random access procedure, the DL message (e.g., an RAR including a TAC or an MsgB including a TAC) is received and the second timer (the second timer may be denoted as a TAT) is started.

In a possible implementation, the pre-configured resource is released and the first timer is stopped as follows. After the contention resolution in the random access procedure succeeds and the reception ACK indication is transmitted, the pre-configured resource is released, and the first timer (the first timer may be denoted as an SDT-TAT) in the running state is stopped. In the random access procedure, the DL message (e.g., an RAR including a TAC or an MsgB including a TAC) is received and the second timer (the second timer may be denoted as a TAT) is started.

In a possible implementation, the method further includes at least one of the following.

Manner 1, the second timer (the second timer may be denoted as a TAT) is stopped after the contention resolution in the random access procedure fails.

Manner 2, continue running the second timer (the second timer may be denoted as a TAT) after the contention resolution in the random access procedure succeeds.

In a possible implementation, in the random access procedure, the pre-configured resource and/or the corresponding first timer is operated to maintain the validity of the TA as follows. Maintain running the first timer (the first timer may be denoted as an SDT-TAT). The first timer is used to maintain the validity of the TA in the UL SDT based on the pre-configured resource.

In a possible implementation, maintain running the first timer as follows. Upon initiating the random access procedure, continue running the first timer (the first timer may be denoted as an SDT-TAT). In the random access procedure, the DL message (e.g., an RAR including a TAC or an MsgB including a TAC) is received and the second timer (the second timer may be denoted as a TAT) is started.

In a possible implementation, the method further includes the following. After the contention resolution in the random access procedure succeeds, the first timer (the first timer may be denoted as an SDT-TAT) is restarted and the second timer (the second timer may be denoted as a TAT) in the running state is stopped. The value of the TA currently maintained by the first timer includes: a value indicated by the TAC in the DL message received after the contention resolution in the random access procedure succeeds. That is, after the contention resolution in the random access procedure succeeds, the value indicated by the TAC obtained from the DL message such as an RAR or an MsgB can be assigned as the value of the TA currently maintained by the first timer (e.g., an SDT-TAT). In other words, an updated value of the TA maintained by the SDT-TAT is actually determined according to the TAC in the DL message.

In a possible implementation, maintain running the first timer as follows. Upon initiating the random access procedure, continue running the first timer (the first timer may be denoted as an SDT-TAT). In the random access procedure, the DL message (e.g., an RAR including a TAC or an MsgB including a TAC) is received and skip starting the second timer (the second timer may be denoted as a TAT).

In a possible implementation, the method further includes the following. The first timer (the first timer may be denoted as an SDT-TAT) is restarted after the contention resolution in the random access procedure succeeds. The value of the TA currently maintained by the first timer includes: a value indicated by the TAC in the DL message (e.g., an RAR including a TAC or an MsgB including a TAC) received after the contention resolution in the random access procedure succeeds. That is, after the contention resolution in the random access procedure succeeds, the value indicated by the TAC obtained from the DL message such as an RAR or an MsgB can be assigned as the value of the TA currently maintained by the first timer (e.g., an SDT-TAT). In other words, an updated value of the TA maintained by the SDT-TAT is actually determined according to the TAC in the DL message.

In a possible implementation, the method further includes at least one of the following.

Manner 1, before the contention resolution in the random access procedure succeeds, the value of the TA maintained by the first timer is assigned as a first TA stored.

Manner 2, after the contention resolution in the random access procedure succeeds, a second TA updated is determined according to the TAC in the DL message, and the value of the TA currently maintained by the first timer is updated as the second TA.

FIG. 6 is a schematic flowchart illustrating a method 600 for TA maintenance in UL synchronization according to an embodiment of the disclosure. The method may be optionally applied to the system illustrated in FIG. 1, but is not limited thereto. The method includes at least part of the following.

S610, a terminal device in an RRC_INACTIVE state receives an RRC message in UL SDT based on a pre-configured resource.

S620, upon reception of the RRC message, the terminal device operates the pre-configured resource and/or a corresponding first timer to maintain validity of a TA.

In some examples, the terminal device may maintain the validity of the TA through the first timer (for example, the TA currently maintained by the first timer is valid when the first timer is in a running state); and/or in the random access procedure, the terminal device may maintain the validity of the TA according to change in reference signal power (for example, the TA is valid if the change in the reference signal power does not exceed a threshold).

It may be noted that, upon reception of the RRC message, the terminal device operates the pre-configured resource and/or the corresponding first timer, to maintain the validity of the TA as follows. After the terminal device receives, through the RRC message, the pre-configured resource and/or the corresponding first timer transmitted by a network device, the terminal device may release the pre-configured resource according to different release occasions and stop the first timer in the running state, to maintain the validity of the TA. In order to maintain the validity of the TA, a value of the TA currently maintained by the first timer is determined according to a value indicated by a TAC in a DL message transmitted by the network device. The TAC is a command transmitted by the network device to the terminal device to adjust its UL transmission, and the terminal device is notified, through the TAC, that the validity of the TA in UL transmission is required to be maintained, to realize the UL synchronization.

Unlike the embodiment in FIG. 5, in this embodiment of the disclosure, although it is also in a CG-SDT scenario, a condition for maintaining the validity of the TA in this embodiment is different from that in the embodiment in FIG. 5. This embodiment of the disclosure emphasizes that a triggering condition for maintaining the validity of the TA is reception of the RRC message. For example, during running of the SDT-TAT, after receiving the RRCResume message, the terminal device releases the CG-SDT resource and stops the SDT-TAT.

In a possible implementation, upon reception of the RRC message, the pre-configured resource and/or the corresponding first timer is operated to maintain the validity of the TA as follows. When the first timer is in a running state, the RRC message is received, the pre-configured resource (e.g., a CG-SDT resource) is released, and the first timer (the first timer may be denoted as an SDT-TAT) is stopped. The first timer is used to maintain the validity of the TA in the UL SDT based on the pre-configured resource.

In a possible implementation, the RRC message includes an RRCResume message.

In a possible implementation, the method further includes the following. When a second timer is in a non-running state, a higher-layer signaling is received and the second timer (the second timer may be denoted as a TAT) is started, to continue maintaining a value of the TA currently stored. The higher-layer signaling indicates a medium access control (MAC) layer to start the second timer. It may be noted that, the MAC layer at the terminal device side maintains the TAT. For the MAC layer, the higher-layer signaling may be a signaling transmitted by an RRC layer to the MAC layer. After the network device side transmits the higher-layer signaling (e.g., an RRC message) to the terminal device, the high-layer signaling is executed at the terminal device side, i.e., the RRC layer indicates the MAC layer to start the TAT.

In a possible implementation, the method further includes the following. When a second timer is in a non-running state, a random access procedure is triggered. In the random access procedure, a DL message (e.g., an RAR including a TAC or an MsgB including a TAC) is received and the second timer (the second timer may be denoted as a TAT) is started. A value of the TA currently maintained by the second timer includes: a value indicated by a TAC in the DL message received in the random access procedure. That is, the value indicated by the TAC obtained from the DL message, such as an RAR or an MsgB, can be assigned as the value of the TA currently maintained by the second timer (e.g., a TAT). In other words, an updated value of the TA maintained by the TAT is actually determined according to the TAC in the DL message.

A method for TA maintenance in UL synchronization still using a conventional timer (referred to as a second timer herein, i.e., a TAT) in an RA-SDT scenario is described as follows.

A method for TA maintenance in UL synchronization in an embodiment of the disclosure is applied to a terminal device and includes the following. The terminal device in an RRC_INACTIVE state operates a second timer (the second timer may be denoted as a TAT) in UL SDT implemented by means of a random access procedure, to maintain validity of a TA.

In a possible implementation, the second timer is operated to maintain the validity of the TA as follows. When the second timer (the second timer may be denoted as a TAT) is in a running state, the validity of the TA is maintained.

In a possible implementation, the method further includes the following. The terminal device receives a system broadcast message, where the second timer (the second timer may be denoted as a TAT) is configured in the system broadcast message.

In a possible implementation, the method further includes the following. After the terminal device completes the first UL SDT, the terminal device continues remaining in the RRC_INACTIVE state for data transmission or data reception.

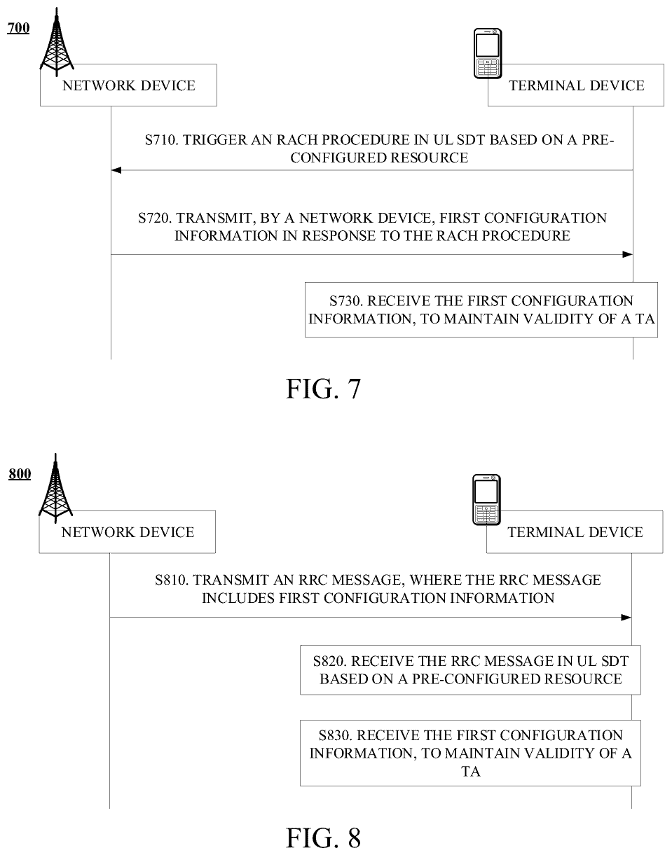

FIG. 7 is a schematic flowchart illustrating a method 700 for TA maintenance in UL synchronization according to an embodiment of the disclosure. The method may be optionally applied to the system illustrated in FIG. 1, but is not limited thereto. The method includes at least part of the following.

S710, a terminal device in an RRC_INACTIVE state triggers a random access procedure in UL SDT based on a pre-configured resource.

S720, a network device transmits first configuration information in response to the random access procedure.

In some examples, the first configuration information includes at least the pre-configured resource and/or a TA, so that the terminal device in the RRC_INACTIVE state can maintain validity of the TA in the UL SDT based on the pre-configured resource.

S730, the terminal device receives the first configuration information, and operates the pre-configured resource and/or a corresponding first timer, to maintain the validity of the TA.

FIG. 8 is a schematic flowchart illustrating a method 800 for TA maintenance in UL synchronization according to an embodiment of the disclosure. The method may be optionally applied to the system illustrated in FIG. 1, but is not limited thereto. The method includes at least part of the following.

S810, a network device transmits an RRC message, where the RRC message includes first configuration information.

In some examples, the first configuration information includes at least a pre-configured resource and/or a TA, so that a terminal device in an RRC_INACTIVE state can maintain validity of the TA in UL SDT based on the pre-configured resource.

S820, the terminal device in the RRC_INACTIVE state receives the RRC message in the UL SDT based on the pre-configured resource.

S830, the terminal device in the RRC_INACTIVE state receives the first configuration information, and operates the pre-configured resource and/or a corresponding first timer to maintain the validity of the TA.

A method for TA maintenance in UL synchronization still using a conventional timer (referred to as a second timer herein, i.e., a TAT) in an RA-SDT scenario is described as follows.

A method for TA maintenance in UL synchronization in an embodiment of the disclosure is applied to a network device and includes the following. In response to a random access procedure, the network device transmits first configuration information. The first configuration information includes at least a pre-configuration resource and/or a TA, so that a terminal device in an RRC_INACTIVE state may operate a second timer (the second timer may be denoted as a TAT) in UL SDT implemented by means of a random access procedure, to maintain validity of the TA.

The methods for TA maintenance in UL synchronization provided in the above embodiments of the disclosure are described in detail below.

In order to ensure time synchronization at the network device side (e.g., an eNodeB side), a TA is required to be maintained in UL data transmission. The TA is used for the UE to perform UL transmission. In order to enable that an UL data packet of the UE arrives at the network device side at a desired time, a radio frequency transmission delay caused by a distance between the UE and the network device is estimated, and a data packet is transmitted in advance at a corresponding time indicated by the TA. For example, due to a relatively large transmission delay, a UE far away from the network device needs to transmit UL data earlier than a UE relatively close to the network device.

In the RRC_INACTIVE state, the SDT is an optional manner for the UL data transmission, and is also required to satisfy an UL synchronization requirement. In a CG-SDT scenario and an RA-SDT scenario, a TA is required to be maintained, so as to achieve UL synchronization.
1. In the CG-SDT scenario, the UE may directly use an uplink resource pre-configured by a network to implement SDT. Since the random access procedure is omitted, the UE needs to ensure that a valid TA exists when the UE initiates the CG-SDT. The UE determines whether the TA is valid, and the protocol may include the following.
1. A timer is introduced, i.e., the UE uses a first timer (e.g., an SDT-TAT) to determine whether the TA is valid, and during running of the first timer, the TA is considered as valid.

It may be noted that the first timer is a new timer introduced for the CG-SDT scenario, and the first timer is different from a conventional TAT maintained by the UE in an RRC_CONNECTED state in the related art. In SDT in the RRC_INACTIVE state, the network device may specify a maintained TA for grant-based SDT, and the first timer may be configured together with a CG configuration in an RRC connection release message.
2) A reference signal receiving power (RSRP) change threshold is introduced. If an RSRP change amount of the terminal does not exceed the threshold (i.e., a pre-configured threshold), the TA is considered as valid. If the RSRP change amount does not exceed the threshold, fallback to the random access procedure is triggered.

The table in the protocol includes at least part or all of the following.

1. A new TA timer for TA maintenance specified for configured grant
based small data transfer in RRC_INACTIVE should be introduced. FFS
on the procedure, the validity of TA, and how to handle expiration of TA
timer. The TA timer is configured together with the CG configuration in
the RRCRelease message.
2. From RAN2 point of view, assume similar to PUR, that we introduce a
TA validation mechanism for SDT based on RSRP change, i.e. RSRP-
based threshold(s) are configured. Ask RAN1 to confirm. FFS on how to
handle CG configuration when TA expires or when is invalid due to RSRP
threshold. Details of the TA validation procedure can be further discussed.
3. Highest N SSBs of all SSBs actually transmitted as indicated in SIB1
is used for RSRP based TA validation.

2. In the RA-SDT scenario, the UE can obtain a valid TA by means of a random access procedure. Since subsequent transmission is supported (the subsequent transmission means that after completing the first UL transmission, the UE continues remaining in the RRC_INACTIVE state for data transmission/reception), the UE needs to continue maintaining the validity of the TA after completing the first UL data transmission. As further discussed, the protocol determines to continue employing the conventional TAT in the related art to maintain the validity of the TA in RA-SDT. In other words, the UE may use a second timer (e.g., a TAT) configured in the system broadcast to determine whether the TA is valid, and during running of the second timer, the TA is considered as valid.

The table in the protocol includes at least part or all of the following.

1. The legacy TAT (i.e. timeAlignmentTimerCommon in SIB) is used for
UL timing maintenance during RA-SDT procedure. (21/23).

3. The selection of a type of SDT in the RRC_INACTIVE state includes the following.

A CG-SDT resource is a UE-specific resource and can be configured via a UE-specific signaling.

An RA-SDT resource is a cell-specific resource contained in a system broadcast message and is shared by UEs in a current cell.
4. During the selection of the type of the SDT in the RRC_INACTIVE state, the UE preferably determines whether a condition (the condition may be referred to as a “first condition” for triggering the UE to initiate the random access procedure in CG-SDT in the following examples) for implementing a CG-SDT scenario is satisfied, and the condition includes at least one of the following conditions 1) to 4).
1). All data to-be-transmitted belongs to a radio bearer (RB) that allows to trigger the SDT in the RRC_INACTIVE state, and a volume of the data to-be-transmitted is not greater than a data volume threshold configured by a network.
2) An RSRP measurement result is not less than an RSRP threshold configured by the network.
3) There is a CG resource on a carrier and a synchronization signal/physical broadcast channel block (SS/PBCH block, SSB) selected.
4) The TA is valid, i.e., the first timer (e.g., an SDT-TAT) is in a running state and/or the RSRP change amount does not exceed the threshold.

In the SDT in the RRC_INACTIVE state in the CG-SDT scenario, after triggering CG-SDT, the UE may transmit a first UL message on a CG resource, where the first UL message may include an RRC message, such as an RRCResumeRequest. Optionally, the first UL message may include user plane (UP)/control plane (CP) data of the UE. The first UL message may further include a buffer status report (BSR) medium access control control element (MAC CE), so that the UE reports a BSR to the network device via the BSR MAC CE of an MAC layer. The first UL message may further include a padding BSR.

After successfully transmitting the first UL message, the UE may continue UL data transmission, i.e., subsequent transmission, based on dynamic scheduling of the network device or by using the CG resource. During the subsequent transmission, in some conditions (for example, there is no SSB satisfying a condition, the TA is invalid, or there is no PUCCH resource for scheduling request (SR) transmission), the UE initiates the random access procedure.

If any one of the foregoing conditions 1) to 4) is not satisfied, the UE further determines whether a condition for implementing an RA-SDT scenario is satisfied.

Some examples of the embodiments of the disclosure are described in detail as follows.

Example 1: the UE initiates a random access procedure in the CG-SDT scenario.

During the selection of the type of the SDT in the RRC_INACTIVE state, the UE preferably determines whether the condition for implementing the CG-SDT scenario is satisfied. The UE in the RRC_INACTIVE state triggers the SDT in the CG-SDT scenario when the first condition (the first condition is described above and is not repeated herein) is satisfied. If the condition configured by the network device for the UE to determine whether the TA is valid includes whether the first timer (e.g., an SDT-TAT) is running, and during running of the first timer (e.g., an SDT-TAT), the TA is considered as valid, the UE initiates the random access procedure in the CG-SDT scenario. Running mechanisms of a TAT and an SDT-TAT include several optional cases as follows.

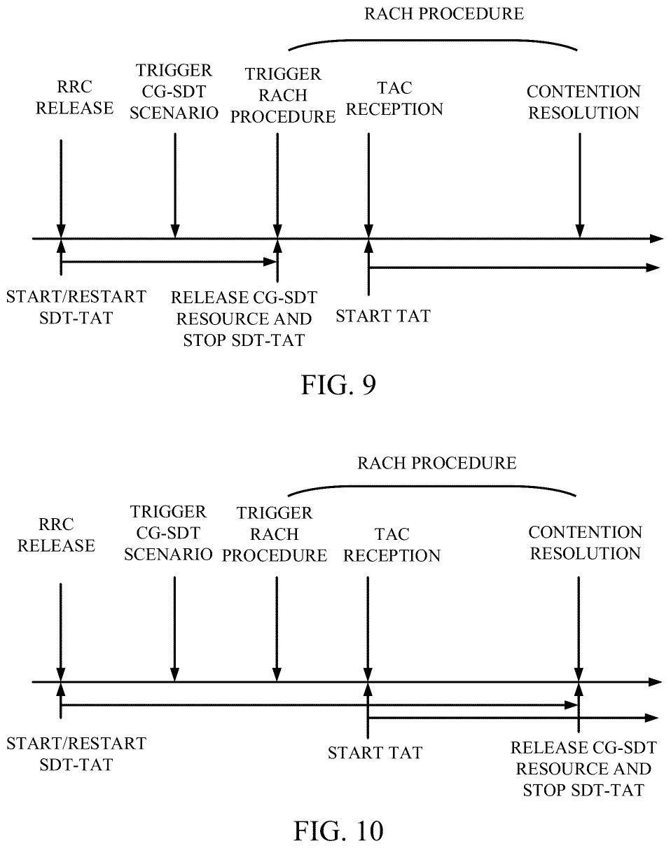

Case 1: as illustrated in FIG. 9, when initiating the random access procedure, the UE initiates a resource release event, e.g., releases the CG-SDT resource, and stops the first timer (e.g., an SDT-TAT) in the running state.

In the random access procedure, after receiving the DL message (e.g., an RAR or an MsgB) transmitted by the network device, the UE starts the second timer (e.g., a TAT) when obtaining the TAC in the DL message. If the contention resolution in the random access procedure fails, the second timer (e.g., a TAT) is stopped, otherwise, maintain running the second timer (e.g., a TAT).

Case 2: as illustrated in FIG. 10, similar to the foregoing case 1, the CG-SDT resource is released, and the first timer (e.g., an SDT-TAT) in the running state is stopped. However, unlike a timing for releasing the CG-SDT resource in case 1, in case 2, the UE releases the CG-SDT resource and stops the first timer (e.g., an SDT-TAT) after the contention resolution in the random access procedure triggered succeeds.

In the random access procedure, after receiving the DL message (e.g., an RAR or an MsgB), the UE starts the second timer (e.g., a TAT) when obtaining the TAC in the DL message. If the contention resolution in the random access procedure fails, the second timer (e.g., a TAT) is stopped, otherwise, maintain running the second timer (e.g., a TAT).

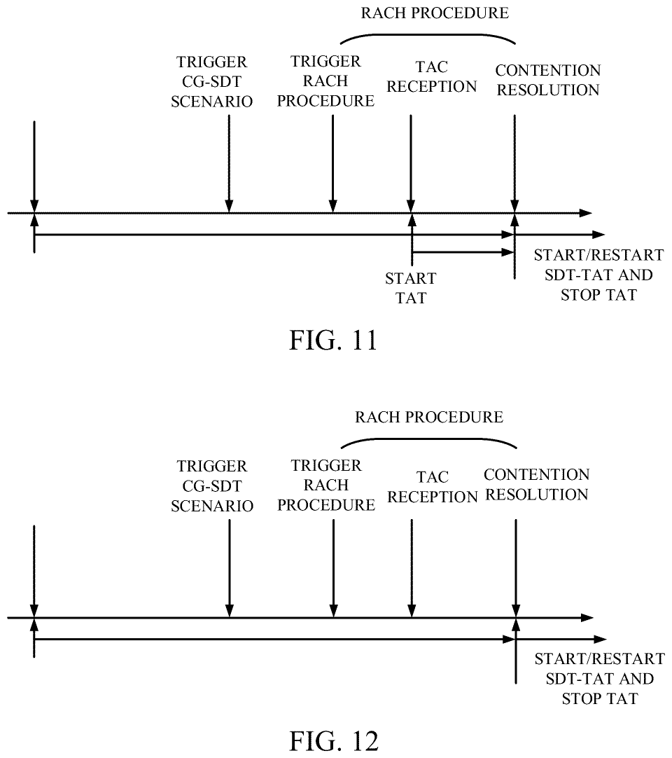

Case 3: as illustrated in FIG. 11, unlike the foregoing case 1 and case 2, in case 3, the CG-SDT resource is not released, the first timer (e.g., an SDT-TAT) is not stopped, and the first timer (e.g., an SDT-TAT) always remains running when the UE initiates the random access procedure.

In the random access procedure, after receiving the DL message (e.g., an RAR or an MsgB), the UE starts the second timer (e.g., a TAT) when obtaining the TAC in the DL message.

After the contention resolution in the random access procedure succeeds, the first timer (e.g., an SDT-TAT) is restarted, the second timer (e.g., a TAT) is stopped, and the TAC obtained from the RAR or the MsgB is assigned as a value of a TA currently maintained by the SDT-TAT. In other words, only after the contention resolution in the random access procedure succeeds, the TAC obtained from the RAR or the MsgB can be assigned as the value of the TA currently maintained by the SDT-TAT.

Specifically, before the contention resolution of the random access procedure succeeds, the value of the TA currently maintained by the SDT-TAT is NTA′, i.e., the UE stores a value NTA of the TA maintained by the first timer (e.g., an SDT-TAT) as NTA′, and a value of the TA received through the RAR or the MsgB is NTA. If the contention resolution in the random access procedure succeeds, the UE restarts NTA (i.e., NTA received through the RAR or the MsgB is stilled assigned as the value of the TA), and deletes NTA′. If the contention resolution in the random access procedure fails, the UE replaces NTA with NTA′.

Case 4: as illustrated in FIG. 12, unlike the foregoing case 1 and case 2, in case 3, the CG-SDT resource is not released, the first timer (e.g., an SDT-TAT) is not stopped, and the first timer (e.g., an SDT-TAT) remains running when the UE initiates the random access procedure. Unlike case 3, in case 4, the second timer (e.g., a TAT) is not started when the random access procedure is initiated, and the value of the TA can be set after the contention resolution in the random access procedure succeeds.

After the contention resolution in the random access procedure succeeds, the first timer (e.g., an SDT-TAT) is restarted, and the TAC obtained from the RAR or the MsgB is assigned as the value of the TA currently maintained by the SDT-TAT.

Specifically, the value of the TA maintained by the first timer (e.g., an SDT-TAT) is NTA. NTA′ is received through the RAR or the MsgB, and the UE stores NTA′. After the contention resolution in the random access procedure succeeds, NTA′ received in the RAR or the MsgB is assigned as the value of the TA currently maintained by the SDT-TAT, i.e., NTA is set as NTA′, otherwise, NTA′ is deleted.

The contention resolution in the random access procedure involved in the described cases succeeds when the UE receives an ID indicating that the contention resolution in the random access procedure succeeds, or after the UE transmits to the network device an ACK message to confirm the successful reception of the ID indicating that the contention resolution in the random access procedure succeeds.

Example 2: during running of the SDT-TAT, the UE receives the RRC message, e.g., an RRCResume message transmitted by the network.

In the SDT in the CG-SDT scenario, during running of the SDT-TAT (it is assumed that the value of the TA maintained by the SDT-TAT is NTA), after the UE receives the RRCResume message transmitted by the network device, the running mechanisms of the TAT and the SDT-TAT include several optional cases as follows.

Case 1: the UE releases the CG-SDT resource, and stops the first timer (e.g., an SDT-TAT). When the second timer (e.g., a TAT) is in a non-running state, the network device indicates an MAC to start the TAT via a higher-layer signaling (e.g., an RRC message), to continue maintaining the value NTA of the TA currently stored.

Case 2: the UE releases the CG-SDT resource, and stops the first timer (e.g., an SDT-TAT). When the second timer (e.g., a TAT) is in the non-running state, the UE initiates the random access procedure to obtain the TAC through the DL message (e.g., an RAR or an MsgB), so as to obtain the value of the TA indicated by the TAC.

It may be noted that, the foregoing examples may be combined with various possibilities in the embodiments of the disclosure, which is not repeated herein.

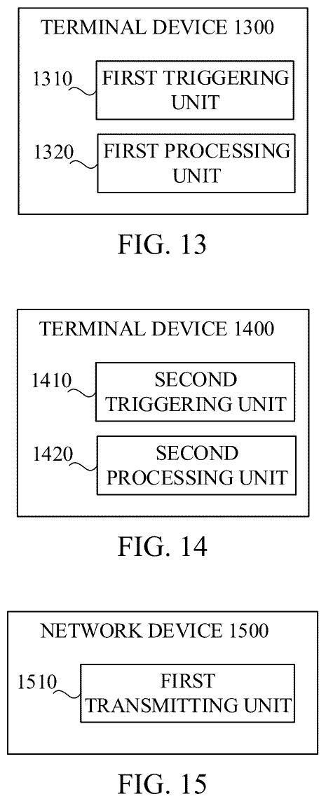

FIG. 13 is a schematic block diagram illustrating a terminal device 1300 according to an embodiment of the disclosure. The terminal device 1300 includes a first triggering unit 1310 and a first processing unit 1320. The first triggering unit 1310 is configured to trigger, by the terminal device in an RRC_INACTIVE state, a random access procedure in UL SDT based on a pre-configured resource. The first processing unit 1320 is configured to operate the pre-configured resource and/or a corresponding first timer to maintain validity of a TA, in the random access procedure.

In a possible implementation, the first processing unit is configured to release the pre-configured resource and stop the first timer, where the first timer is used to maintain the validity of the TA in the UL SDT based on the pre-configured resource.

In a possible implementation, the first processing unit is configured to release the pre-configured resource and stop the first timer in a running state, upon initiating the random access procedure. The first processing unit is configured to receive a DL message and start a second timer, in the random access procedure.

In a possible implementation, the first processing unit is configured to release the pre-configured resource and stop the first timer in a running state, when contention resolution in the random access procedure succeeds. The first processing unit is configured to receive a DL message and start a second timer, in the random access procedure.

In a possible implementation, the first processing unit is configured to release the pre-configured resource and stop the first timer in a running state, after contention resolution in the random access procedure succeeds and a reception ACK indication is transmitted. The first processing unit is configured to receive a DL message and start a second timer, in the random access procedure.

In a possible implementation, the first processing unit is configured to operate the second timer by means of at least one of: stopping the second timer after contention resolution in the random access procedure fails; or continuing running the second timer after the contention resolution in the random access procedure succeeds.

In a possible implementation, the first processing unit is configured to maintain running the first timer. The first timer is used to maintain the validity of the TA in the UL SDT based on the pre-configured resource.

In a possible implementation, the first processing unit is configured to continue running the first timer, upon initiating the random access procedure. The first processing unit is configured to receive a DL message and start a second timer, in the random access procedure.

In a possible implementation, the first processing unit is configured to restart the first timer and stop the second timer in a running state, after contention resolution in the random access procedure succeeds. A value of the TA currently maintained by the first timer includes: a value indicated by a TAC in the DL message received after the contention resolution in the random access procedure succeeds.

In a possible implementation, the first processing unit is configured to continue running the first timer, upon initiating the random access procedure. The first processing unit is configured to receive a DL message and skip starting a second timer, in the random access procedure.

In a possible implementation, the first processing unit is configured to restart the first timer after contention resolution in the random access procedure succeeds. A value of the TA currently maintained by the first timer includes: a value indicated by a TAC in the DL message received after the contention resolution in the random access procedure succeeds.

In a possible implementation, the first processing unit is configured to operate the first timer by means of at least one of: before the contention resolution in the random access procedure succeeds, assigning the value of the TA maintained by the first timer as a first TA stored; or after the contention resolution in the random access procedure succeeds, determining, according to the TAC in the DL message, a second TA updated, and updating the value of the TA currently maintained by the first timer as the second TA.

FIG. 14 is a schematic block diagram illustrating a terminal device 1400 according to an embodiment of the disclosure. The terminal device 1400 includes a second triggering unit 1410 and a second processing unit 1420. The second triggering unit 1410 is configured to receive, by the terminal device in an RRC_INACTIVE state, an RRC message in UL SDT based on a pre-configured resource. The second processing unit 1420 is configured to operate the pre-configured resource and/or a corresponding first timer to maintain validity of a TA, upon reception of the RRC message.

In a possible implementation, the second processing unit is configured to receive the RRC message, release the pre-configured resource, and stop the first timer, when the first timer is in a running state. The first timer is used to maintain the validity of the TA in the UL SDT based on the pre-configured resource.

In a possible implementation, the RRC message includes an RRCResume message.

In a possible implementation, the second processing unit is configured to receive a higher-layer signaling and start a second timer, to continue maintaining a value of the TA currently stored, when the second timer is in a non-running state. The higher-layer signaling indicates an MAC layer to start the second timer.

In a possible implementation, the second processing unit is configured to trigger a random access procedure when a second timer is in a non-running state. The second processing unit is configured to receive a DL message and start the second timer, in the random access procedure. A value of the TA currently maintained by the second timer includes: a value indicated by a TAC in the DL message received in the random access procedure.

A terminal device according to an embodiment of the disclosure may include a third processing unit. The third processing unit is configured to operate, by the terminal device in an RRC_INACTIVE state, a second timer in UL SDT implemented by means of a random access procedure, to maintain validity of a TA.

In a possible implementation, the third processing unit is configured to maintain the validity of the TA when the second timer denoted as a TAT is in a running state.

In a possible implementation, the terminal device further includes a first receiving unit. The first receiving unit is configured to receive a system broadcast message, where the TAT is configured in the system broadcast message.

In a possible implementation, the terminal device further includes a first transmitting unit. The first transmitting unit is configured to continue remaining in the RRC_INACTIVE state for data transmission/reception, after a first UL SDT is completed.

The terminal device in embodiments of the disclosure can implement corresponding functions of the terminal device in the foregoing method embodiments. For processes, functions, implementations, and beneficial effects corresponding to various modules (sub-modules, units, components, etc.) in the terminal device, reference can be made to the corresponding description in the foregoing method embodiments, which will not be repeated herein. It needs to be noted that, the described functions of various modules (sub-modules, units, components, etc.) in the terminal device in embodiments of the disclosure can be implemented by different modules (sub-modules, units, components, etc.) or by the same module (sub-module, unit, component, etc.).

FIG. 15 is a schematic block diagram illustrating a network device 1500 according to an embodiment of the disclosure. The network device 1500 includes a first transmitting unit 1510. The first transmitting unit 1510 is configured to transmit first configuration information in response to a random access (RACH) procedure. The first configuration information includes at least a pre-configured resource and/or a TA, so that a terminal device in an RRC_INACTIVE state can maintain validity of the TA in UL SDT based on the pre-configured resource.

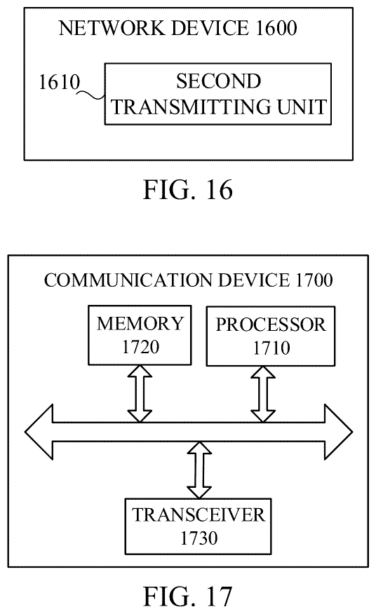

FIG. 16 is a schematic block diagram illustrating a network device 1600 according to an embodiment of the disclosure. The network device 1600 includes a second transmitting unit 1610. The second transmitting unit 1610 is configured to transmit an RRC message. The RRC message includes first configuration information. The first configuration information includes at least a pre-configured resource and/or a TA, so that a terminal device in an RRC_INACTIVE state can maintain validity of the TA in UL SDT based on the pre-configured resource.

A network device according to an embodiment of the disclosure may include a third transmitting unit. The third transmitting unit is configured to transmit first configuration information in response to an RACH procedure. The first configuration information includes at least a pre-configured resource and/or a TA, so that a terminal device in an RRC_INACTIVE state can maintain validity of the TA in UL SDT implemented by means of the RACH procedure.

The network device in embodiments of the disclosure can implement corresponding functions of the network device in the foregoing method embodiments. For processes, functions, implementations, and beneficial effects corresponding to various modules (sub-modules, units, components, etc.) in the network device, reference can be made to the corresponding description in the foregoing method embodiments, which will not be repeated herein. It needs to be noted that, the described functions of various modules (sub-modules, units, components, etc.) in the network device in embodiments of the disclosure can be implemented by different modules (sub-modules, units, components, etc.) or by the same module (sub-module, unit, component, etc.).

FIG. 17 is a schematic block diagram illustrating a communication device 1700 according to embodiments of the disclosure. The communication device 1700 includes a processor 1710. The processor 1710 is configured to invoke and execute computer programs stored in a memory, to cause the communication device 1700 to perform the method in embodiments of the disclosure.

Optionally, the communication device 1700 may further include a memory 1720. The processor 1710 is configured to invoke and execute computer programs stored in the memory 1720, to cause the communication device 1700 to perform the method in embodiments of the disclosure.

The memory 1720 may be a separate device independent of the processor 1710, or may be integrated in the processor 1710.

Optionally, the communication device 1700 may further include a transceiver 1730. The processor 1710 can be configured to control the transceiver 1730 to communicate with other devices. Specifically, the transceiver 1730 can be configured to transmit information or data to other devices, or receive information or data transmitted by other devices.

The transceiver 1730 may include a transmitter and a receiver. The transceiver 1730 may further include one or more antennas.

Optionally, the communication device 1700 may be the network device in the embodiments of the disclosure, and the communication device 1700 can implement the corresponding process implemented by the network device in various methods according to embodiments of the disclosure, which will not be repeated herein for the sake of simplicity.

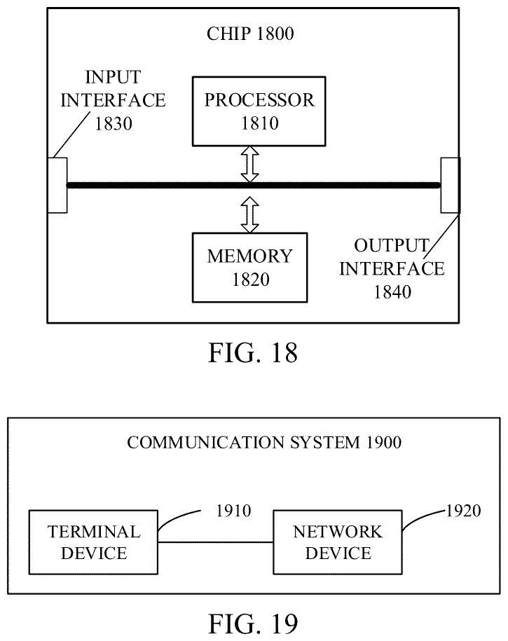

Optionally, the communication device 1700 may be the terminal device in the embodiments of the disclosure, and the communication device 1700 can implement the corresponding process implemented by the terminal device in various methods according to embodiments of the disclosure, which will not be repeated herein for the sake of simplicity. FIG. 18 is a schematic block diagram illustrating a chip 1800 according to embodiments of the disclosure. The chip 1800 includes a processor 1810. The processor 1810 is configured to invoke and execute computer programs stored in a memory to perform the method in embodiments of the disclosure.

Optionally, the chip 1800 may further include a memory 1820. The processor 1810 is configured to invoke and execute computer programs stored in the memory 1820 to perform the method performed by the terminal device or the network device in embodiments of the disclosure.

The memory 1820 may be a separate device independent of the processor 1810, or may be integrated in the processor 1810.

Optionally, the chip 1800 may further include an input interface 1830. The processor 1810 can be configured to control the input interface 1830 to communicate with other devices or chips. Specifically, the input interface 1830 can be configured to obtain information or data transmitted by other devices or chips.

Optionally, the chip 1800 may further include an output interface 1840. The processor 1810 can be configured to control the output interface 1840 to communicate with other devices or chips. Specifically, the output interface 1840 can be configured to output information or data to other devices or chips.

Optionally, the chip can be applied to the network device in the embodiments of the disclosure, and the chip can implement the corresponding process implemented by the network device in various methods according to embodiments of the disclosure, which will not be repeated herein for the sake of simplicity.

Optionally, the chip can be applied to the terminal device in the embodiments of the disclosure, and the chip can implement the corresponding process implemented by the terminal device in various methods according to embodiments of the disclosure, which will not be repeated herein for the sake of simplicity.

The chips respectively applied to the network device and the terminal device may be the same chip or different chips.

It may be understood that, the chip mentioned in the embodiments of the disclosure may also be referred to as a system-level chip, a system chip, a chip system, a system-on-a-chip chip, or the like.

The processor mentioned above may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor may be a microprocessor, or may also be any conventional processor, or the like.

The memory mentioned above may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It may be understood that, the memory mentioned above is an example rather than limitation. For example, the memory may be a static RAM (SRAM), a dynamic RAM (DRAM), a synchronous DRAM (SDRAM), a double data rate SDRAM (DDRSDRAM), an enhanced SDRAM (ESDRAM), a synclink DRAM (SLDRAM), and a direct rambus RAM (DRRAM). That is, the memory in embodiments of the disclosure is intended to include, but is not limited to, these and any other suitable types of memory.

FIG. 19 is a schematic block diagram illustrating a communication system 1900 according to embodiments of the disclosure. The communication system 1900 includes a terminal device 1910 and a network device 1920. The terminal device 1910 may include a first triggering unit and a first processing unit. The first triggering unit is configured to trigger, by the terminal device in an RRC_INACTIVE state, a random access procedure in UL SDT based on a pre-configured resource. The first processing unit is configured to operate the pre-configured resource and/or a corresponding first timer to maintain validity of a TA, in the random access procedure. The network device 1920 may include a first transmitting unit. The first transmitting unit is configured to transmit first configuration information in response to the random access procedure. The first configuration information includes at least the pre-configured resource and/or the TA, so that the terminal device in the RRC_INACTIVE state can maintain the validity of the TA in the UL SDT based on the pre-configured resource. The terminal device 1910 can be configured to implement the corresponding function implemented by the terminal device in the method, and the network device 1920 can be configured to implement the corresponding function implemented by the network device in the method, which will not be repeated herein for the sake of simplicity.

All or part of the above embodiments can be implemented through software, hardware, firmware, or any other combination thereof. When implemented by software, all or part of the above embodiments can be implemented in a form of a computer program product. The computer program product includes one or more computer instructions. When the computer program instructions are loaded and executed on a computer, all or part of the processes or functions of the embodiments of the disclosure are performed. The computer may be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. Examples of the wired manner may be, for example, a coaxial cable, an optical fiber, a digital subscriber line (DSL), etc. The wireless manner may be, for example, infrared, wireless, microwave, etc. The computer-readable storage medium may be any computer accessible usable-medium or a data storage device such as a server, a data center, or the like which is integrated with one or more usable media. The usable medium may be a magnetic medium (e.g., a soft disc, a hard disc, or a magnetic tape), an optical medium (e.g., a digital video disc (DVD)), or a semiconductor medium (e.g., a solid state disk (SSD)), etc.

It may be understood that, in various embodiments of the disclosure, the magnitude of a sequence number of each process does not mean an order of execution, and the order of execution of each process may be determined by its function and an internal logic and shall not constitute any limitation to an implementation process in embodiments of the disclosure.

It will be evident to those skilled in the art that, for the sake of convenience and simplicity, for the specific working processes of the foregoing systems, apparatuses, and units, reference can be made to the corresponding processes in the foregoing method embodiments, which will not be repeated herein.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure should be stated in the scope of protection of the claims.

What is claimed is:

1. A method for timing advance (TA) maintenance in uplink (UL) synchronization, being applied to a terminal device and comprising:
triggering, by the terminal device in a radio resource control (RRC) inactive state, a random access procedure in UL small data transmission (SDT) based on a pre-configured resource; and
in the random access procedure, operating the pre-configured resource and/or a corresponding first timer to maintain validity of a TA.

2. The method of claim 1, wherein in the random access procedure, operating the pre-configured resource and/or the corresponding first timer to maintain the validity of the TA comprises:
releasing the pre-configured resource and stopping the first timer, wherein the first timer is used to maintain the validity of the TA in the UL SDT based on the pre-configured resource.

3. The method of claim 1, wherein releasing the pre-configured resource and stopping the first timer comprises:
upon initiating the random access procedure, releasing the pre-configured resource and stopping the first timer in a running state; and
in the random access procedure, receiving a downlink (DL) message and starting a second timer.

4. The method of claim 1, wherein releasing the pre-configured resource and stopping the first timer comprises:
when contention resolution in the random access procedure succeeds, releasing the pre-configured resource and stopping the first timer in a running state; and
in the random access procedure, receiving a DL message and starting a second timer.

5. The method of claim 1, wherein releasing the pre-configured resource and stopping the first timer comprises:
after contention resolution in the random access procedure succeeds and a reception acknowledgement (ACK) indication is transmitted, releasing the pre-configured resource and stopping the first timer in a running state; and
in the random access procedure, receiving a DL message and starting a second timer.

6. The method of claim 3, further comprising at least one of:
stopping the second timer after contention resolution in the random access procedure fails; or
continuing running the second timer after the contention resolution in the random access procedure succeeds.

7. The method of claim 1, wherein in the random access procedure, operating the pre-configured resource and/or the corresponding first timer to maintain the validity of the TA comprises:
maintaining running the first timer;
wherein the first timer is used to maintain the validity of the TA in the UL SDT based on the pre-configured resource.

8. The method of claim 1, wherein maintaining running the first timer comprises:
upon initiating the random access procedure, continuing running the first timer; and
in the random access procedure, receiving a DL message and starting a second timer.

9. The method of claim 8, further comprising:
after contention resolution in the random access procedure succeeds, restarting the first timer and stopping the second timer in a running state;
wherein a value of the TA currently maintained by the first timer comprises: a value indicated by a timing advance command (TAC) in the DL message received after the contention resolution in the random access procedure succeeds.

10. The method of claim 1, wherein maintaining running the first timer comprises:
upon initiating the random access procedure, continuing running the first timer; and
in the random access procedure, receiving a DL message and skipping starting a second timer.

11. A terminal device, comprising:
a memory configured to store computer programs; and
a processor configured to invoke and execute the computer programs stored in the memory, to cause the terminal device to:
trigger, in a radio resource control (RRC) inactive state, a random access procedure in uplink (UL) small data transmission (SDT) based on a pre-configured resource; and
operate the pre-configured resource and/or a corresponding first timer to maintain validity of a timing advance (TA), in the random access procedure.

12. The terminal device of claim 11, wherein the processor is configured to cause the terminal device to:
release the pre-configured resource and stop the first timer in a running state, upon initiating the random access procedure; and
receive a downlink (DL) message and start a second timer, in the random access procedure.

13. The terminal device of claim 12, wherein the processor is configured to cause the terminal device to operate the second timer by means of at least one of:
stopping the second timer after contention resolution in the random access procedure fails; or
continuing running the second timer after the contention resolution in the random access procedure succeeds.

14. The terminal device of claim 11, wherein the processor is configured to cause the terminal device to:
maintain running the first timer;
wherein the first timer is used to maintain the validity of the TA in the UL SDT based on the pre-configured resource.

15. The terminal device of claim 11, wherein the processor is configured to cause the terminal device to:
continue running the first timer, upon initiating the random access procedure; and
receive a DL message and start a second timer, in the random access procedure.

16. The terminal device of claim 15, wherein the processor is configured to cause the terminal device to:
restart the first timer and stop the second timer in a running state, after contention resolution in the random access procedure succeeds;
wherein a value of the TA currently maintained by the first timer comprises: a value indicated by a timing advance command (TAC) in the DL message received after the contention resolution in the random access procedure succeeds.

17. The terminal device of claim 11, wherein the processor is configured to cause the terminal device to:
continue running the first timer, upon initiating the random access procedure; and
receive a DL message and skip starting a second timer, in the random access procedure.

18. The terminal device of claim 17, wherein the processor is configured to cause the terminal device to:
restart the first timer after contention resolution in the random access procedure succeeds;
wherein a value of the TA currently maintained by the first timer comprises: a value indicated by a TAC in the DL message received after the contention resolution in the random access procedure succeeds.

19. The terminal device of claim 16, wherein the processor is configured to cause the terminal device to operate the first timer by means of at least one of:
before the contention resolution in the random access procedure succeeds, assigning the value of the TA maintained by the first timer as a first TA stored; or
after the contention resolution in the random access procedure succeeds, determining, according to the TAC in the DL message, a second TA updated, and updating the value of the TA currently maintained by the first timer as the second TA.

20. A chip comprising:
a processor configured to execute computer programs stored in a memory to cause a device equipped with the chip to:
trigger, in a radio resource control (RRC) inactive state, a random access procedure in UL small data transmission (SDT) based on a pre-configured resource; and
in the random access procedure, operate the pre-configured resource and/or a corresponding first timer to maintain validity of a TA.
